(19) United States
(12) Patent Application Publication
(10) Pub. No.: US 2020/0108915 A1
(43) Pub. Date: Apr. 9, 2020

(54) ENGINE ASSEMBLY WITH POROUS SURFACE OF BOUNDARY LAYER SUCTION

(71) Applicant: PRATT & WHITNEY CANADA CORP., Longueuil (CA)

(72) Inventors: Jean THOMASSIN, Sainte-Julie (CA); Andre JULIEN, Sainte-Julie (CA)

(21) Appl. No.: 16/199,021

(22) Filed: Nov. 23, 2018

Related U.S. Application Data
(60) Provisional application No. 62/741,727, filed on Oct. 5, 2018.

(51) Int. Cl. B64C 21/06; B64D 33/10; F01C 21/06; F02B 33/40; B64D 27/06

(52) U.S. Cl. CPC B64C 21/06; B64D 33/10; F02B 2053/005; F02B 33/40; B64D 27/06; F01C 21/06

(57) ABSTRACT

There is disclosed an engine assembly, including an internal combustion engine having a housing and a coolant circuitry in heat exchange relationship with the housing. A porous surface is configured for defining a portion of an external surface of an aircraft. Apertures are defined through the porous surface. The housing of the internal combustion engine is in heat exchange relationship with the porous surface for heating the porous surface. An air conduit has an inlet fluidly connected to a boundary layer region outside the engine assembly and adjacent the porous surface via the apertures of the porous surface. The air conduit is in heat exchange relationship with the coolant circuitry. A forced air system is fluidly connected to the inlet of the air conduit and is operable to draw an airflow from the inlet and inside the air conduit. A method of operating the engine assembly is disclosed.

### CROSS-REFERENCE TO RELATED APPLICATIONS

This application claims priority from U.S. provisional patent application No. 62/741,727, filed Oct. 5, 2018, the entire content of each of which is incorporated by reference herein.

### TECHNICAL FIELD

The application relates generally to aircraft engines and, more particularly, to systems and methods used for cooling such engines.

### BACKGROUND OF THE ART

An engine requires cooling for proper operation. Usually, the cooling is carried by transferring heat from the engine to an airflow drawn from an environment outside an aircraft containing the engine. However, doing so negatively affects performance of the aircraft by creating a cooling drag. Consequently, improvements are possible.

### SUMMARY

In accordance with a general aspect, there is provided an engine assembly, comprising: a liquid-cooled internal combustion engine having a housing, the internal combustion engine including a coolant circuitry for circulating a liquid coolant, the coolant circuitry in heat exchange relationship with the housing; a porous surface configured for defining a portion of an external surface of an aircraft, apertures defined through the porous surface, the housing of the internal combustion engine in heat exchange relationship with the porous surface for heating the porous surface; an air conduit having an inlet fluidly connected to a boundary layer region outside the engine assembly and adjacent the porous surface via the apertures of the porous surface, the air conduit in heat exchange relationship with the coolant circuitry; and a forced air system fluidly connected to the inlet of the air conduit and operable to draw an airflow from the inlet and inside the air conduit.

In accordance with another general aspect, there is provided an engine assembly, comprising: a turbo-compounded engine including a rotary internal combustion engine having an housing and an engine shaft, the intermittent internal combustion engine including a coolant circuitry for circulating a liquid coolant, the coolant circuitry in heat exchange relationship with the housing, and a turbine having a turbine shaft, the turbine having an inlet fluidly connected to an exhaust of the intermittent internal combustion engine, the turbine shaft in driving engagement with the engine shaft; a porous surface configured for defining a portion of an external surface of an aircraft, apertures defined through the porous surface, the housing of the internal combustion engine in heat exchange relationship with the porous surface for heating the porous surface; an air conduit having an inlet fluidly connected to a boundary layer region outside the engine assembly via the apertures of the porous surface, the air conduit in heat exchange relationship with the coolant circuitry; a forced air system fluidly connected to the inlet of the air conduit and operable to draw an airflow from the inlet and inside the air conduit.

In accordance with a further general aspect, there is provided a method of operating an engine assembly comprising: heating a portion of an external surface of an aircraft being porous with heat generated by an internal combustion engine; drawing an airflow from a boundary layer region located over the portion of the external surface to an air conduit; and heating the airflow while circulating the airflow in the air conduit by cooling a liquid coolant being in heat exchange relationship with a housing of the internal combustion engine.

### DESCRIPTION OF THE DRAWINGS

Reference is now made to the accompanying figures in which:

FIG. 1 is a schematic cross-sectional view of an engine assembly in accordance with a particular embodiment;

FIG. 2 is a schematic cross-sectional view of a possible implementation of the engine assembly of FIG. 1;

FIG. 3 is a schematic top view a wing defining a porous surface of the engine assembly of FIG. 1; and

FIG. 4 is a schematic cross-sectional view along line 4-4 of FIG. 3.

### DETAILED DESCRIPTION

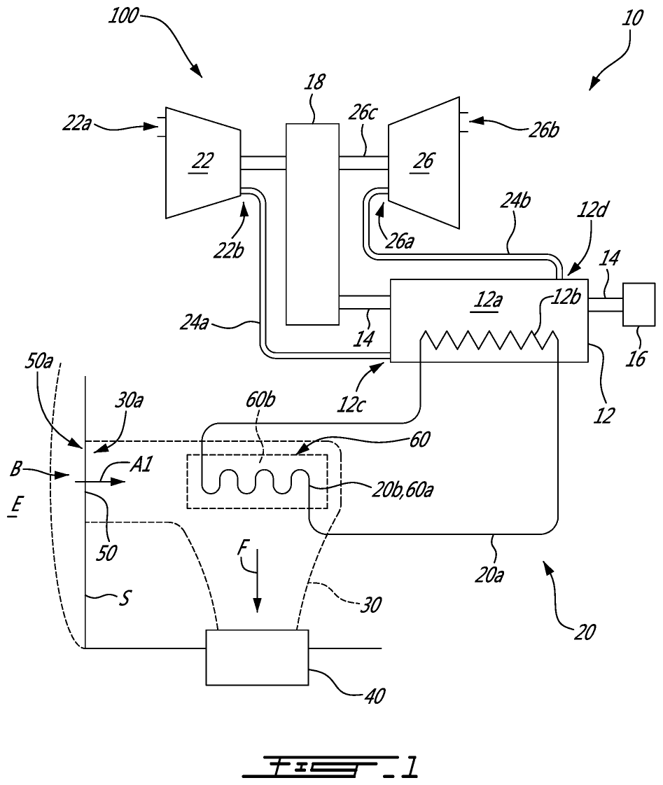

Referring to FIG. 1, an engine assembly 10 is generally shown and includes an internal combustion engine 12, which may be any type of intermittent internal combustion engine. In a particular embodiment, the internal combustion engine 12 comprises one or more rotary units each configured for example as a Wankel engine, or one or more reciprocating pistons. The internal combustion engine 12 drives an engine shaft 14 that is used for driving a rotatable load 16. It is understood that the engine assembly 10 may alternately be configured to drive any other appropriate type of load, including, but not limited to, one or more generator(s), propeller(s), accessory(ies), rotor mast(s), compressor(s), or any other appropriate type of load or combination thereof.

The internal combustion engine 12 may be a liquid cooled internal combustion engine in which a liquid coolant is used to extract heat generated by combustion of a mixture of fuel and air within at least one combustion chamber of the engine. It is understood that, in a liquid cooled internal combustion engine, the at least one combustion chamber is fluidly disconnected from an environment outside of the at least one combustion chamber at least during the combustion of the mixture; the at least one combustion chamber opening to the environment after said combustion to expel the exhaust gases generated therein. Consequently, in such engines, as the combustion occurs in an enclosed space (i.e., the at least one combustion chamber being fluidly disconnected from the environment), the engine accumulates a lot of heat that needs to be dissipated via the liquid coolant.

In a particular embodiment, the engine assembly 10 is a compound cycle engine system or compound cycle engine such as described in Lents et al.'s U.S. Pat. No. 7,753,036 issued Jul. 13, 2010 or as described in Julien et al.'s U.S. Pat. No. 7,775,044 issued Aug. 17, 2010, or as described in Thomassin et al.'s U.S. patent publication No. 2015/0275749 published Oct. 1, 2015, or as described in Bolduc et al.'s U.S. patent publication No. 2015/0275756 published Oct. 1, 2015, the entire contents of all of which are incorporated by reference herein. The engine assembly 10 may be used as a prime mover engine, such as on an aircraft or other vehicle, or in any other suitable application.

In a particular embodiment, the internal combustion engine 12 is a rotary engine comprising three rotary units each configured as a Wankel engine, with a rotor cavity having a profile defining two lobes, preferably an epitrochoid, in which a rotor is received with the geometrical axis of the rotor being offset from and parallel to the axis of the rotor cavity, and with the rotor having three circumferentially-spaced apex portions and a generally triangular profile with outwardly arched sides, so as to define three rotating combustion chambers with variable volume. Alternatively, the internal combustion engine 12 may be any type of intermittent internal combustion engine such as a piston engine.

In the embodiment shown, the engine assembly 10 is an auxiliary power unit (APU) and the engine shaft 14 is in driving engagement with a generator. As shown, the engine shaft 14 is directly engaged to the generator. Alternatively, the engine shaft 14 may be drivingly engaged to the generator via a gearbox 18 of the engine assembly 10.

The internal combustion engine 12 has an housing 12a that defines the combustion chambers. The housing 12a usually gets hot because of explosions of a mixture of air and fuel in the combustion chambers. Therefore, the housing 12a is cooled.

In the embodiment shown, a coolant circuitry 20 is used for circulating a liquid coolant, which may be any suitable liquid coolant such as oil and propylene glycol. The coolant circuitry 20 is in heat exchange relationship with the housing. As illustrated on FIG. 1, the coolant circuitry 20 includes a conduit 20a that circulates the liquid coolant in an out of the housing 12a and a coolant flow path 12b defined within the housing 12a and that is fluidly connected to the conduit 20a. The liquid coolant picks up heat from the housing 12a while it circulates within the coolant flow path 12b of the housing 12a and heat is expelled from the liquid coolant via a portion 20b of the conduit 20a that is in heat exchange relationship with another medium of lower temperature than that of the liquid coolant exiting the housing of the internal combustion engine 12.

It is understood that the coolant circuitry may be used to extract heat from any kind of heat sources, such as, the engine 12, batteries, generators, electric motors, aircraft systems and accessories, either in combination or individually.

In the embodiment shown, the internal combustion engine 12 is a component of a turbo-compounded engine 100 of the engine assembly 10; the turbo-compounded engine 100 including a compressor 22 for compressing the air before it is fed to an air inlet 12c of the internal combustion engine 12. As illustrated, the compressor 22 has an inlet 22a fluidly connected to an environment E outside of the engine assembly 10 and an outlet 22b fluidly connected via a conduit 24a to the inlet 12c of the internal combustion engine 12 for feeding compressed air to the internal combustion engine 12.

As illustrated, the turbo-compounded engine 100 includes a turbine 26 receiving the exhaust gases from the internal combustion engine 12. The turbine 26 has an inlet 26a fluidly connected via a conduit 24b to an exhaust 12d of the internal combustion engine 12. The turbine 26 has an outlet 26b fluidly connected to the environment E for expelling exhaust gases generated by the internal combustion engine 12 and after their passage in the turbine 26.

In the case of a rotary engine, the internal combustion engine 12 provides an exhaust flow of high pressure hot gas exiting at high peak velocity, in the form of exhaust pulses. The turbine 26 may comprise a single turbine, or two or more turbine stages in serial fluid communication; the two or more turbine stages may have different reaction ratios from one another and might be configured to cater to the exhaust pulses of the internal combustion engine 12. Other configurations are contemplated.

It is understood that variations are possible, and that, for example, the compressor 22 and/or turbine 26 may be omitted without departing from the scope of the present disclosure.

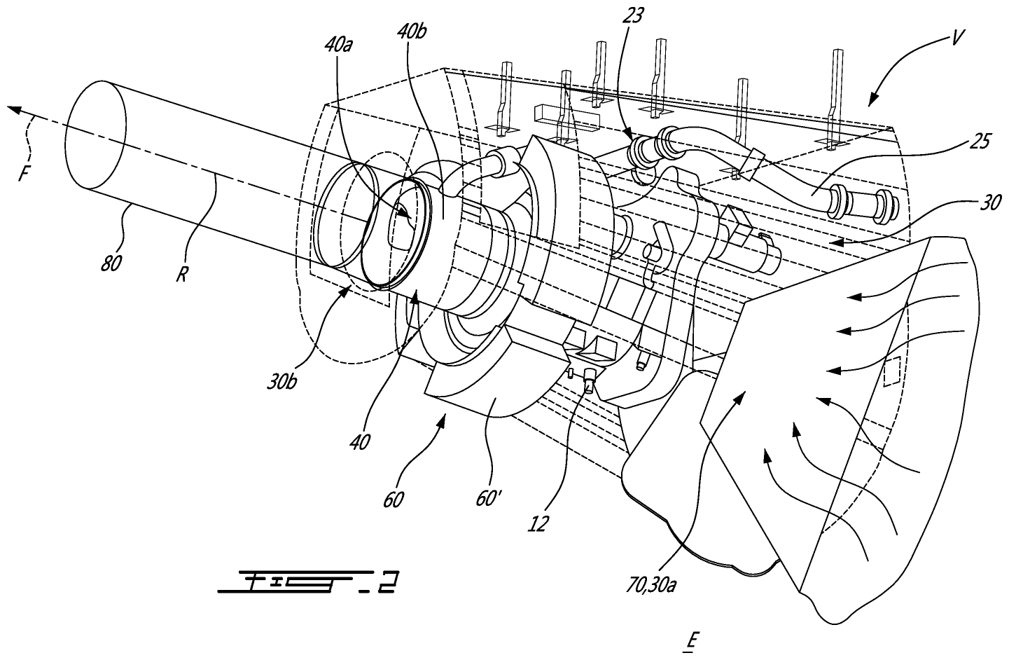

In the illustrated embodiment, the compressor 22 and the turbine 26 are in a driving engagement with the gearbox 18. In the illustrated embodiment, the compressor 22 and turbine 26 rotors are engaged to a same turbine shaft 26c, which is drivingly engaged to the engine shaft 14 through the gearbox 18; the turbine shaft 26c and the engine shaft 14 are parallel and radially offset from one another. Alternate configurations are possible, including, but not limited to, the rotor(s) of the compressor 22 being engaged to a shaft separate from the turbine shaft 26c (whether coaxial with the turbine shaft 26c, with the engine shaft 14, or offset from both) and in driving engagement with the turbine shaft 26c and/or the engine shaft 14, for example through the gearbox 18; and/or two or more of the shafts extending at an angle (perpendicularly or otherwise) to each other. In the embodiment shown, the engine assembly 10 includes a load compressor 23 (FIG. 2) configured for supplying compressed air to a cabin of the aircraft via a conduit 25. The load compressor 23 has a compressor shaft that may be in driving engagement with the turbine shaft 26c either directly or via the gearbox 18.

In the depicted embodiment, energy from the exhaust gases exiting the internal combustion engine 18 is extracted by the turbine 26; the energy extracted by the turbine 26 being compounded with the internal combustion engine 12 to drive the engine shaft 14 via the gearbox 18.

In the depicted embodiment, the engine assembly 10 includes an air conduit 30 that has an inlet 30a fluidly connected to the environment E outside the engine assembly 10. The air conduit 30 is in heat exchange relationship with the coolant circuitry 20. As illustrated, the portion 20b of the conduit 20a of the coolant circuitry 20 is located within the air conduit 30 such that an airflow F circulating therein will contact the conduit 20a and be able to pick up heat from the conduit 20a via convection between the conduit 20a and the airflow F.

In the depicted embodiment, the engine assembly 10 further includes a forced air system 40 fluidly connected to the inlet 30a of the air conduit 30 and operable to draw the airflow F from the inlet 30a and inside the air conduit. The forced air system 40 may be a blower (e.g., a fan within a fan casing) or a scoop configured for creating a pressure differential between the air conduit 30 and the environment E to draw air through the inlet 30a of the air conduit 30. The forced air system 40 may be electronically, hydraulically, pneumatically, or mechanically driven. In a particular embodiment, the forced air system 40 is in driving engagement with the engine shaft 14 of the internal combustion engine 12, either directly or via the gearbox 18 and/or other transmission means.

However, it has been observed that simply drawing air from the environment E in the air conduit 30 creates a cooling drag. The cooling drag impairs performance of an aircraft containing the engine assembly 10. Therefore, it might be advantageous to draw the air from a boundary layer region B of a portion of an external surface S of the aircraft. More specifically, a boundary layer is created when the aircraft moves with respect to surrounding air. For a surface, the boundary layer is usually laminar at the beginning of the surface and develops to become turbulent as it moves away from the beginning of the surface. The drag created by a turbulent boundary layer is greater than a drag created by a laminar boundary layer. The boundary layer has a height taken in a direction normal to the surface S that increases from the beginning of the surface S. Typically, the height of a turbulent boundary layer is greater than that of a laminar boundary layer. The greater is the height of the boundary layer, the greater is the drag. Therefore, it might be possible to suck air from the boundary layer region B to reduce the height of the boundary layer.

Systems for boundary layer suction already exist, but their operation does not necessarily result in an improved performance of the aircraft. Indeed, energy must be provided to draw the air of the boundary layer region B. Consequently, the added cost resulting from the suction of the boundary layer is not necessarily compensated by the drag reduction resulting from said suction.

In the present case, the housing 12a of the internal combustion engine 12 requires a lot of air for cooling. The rationale is as follows: as long as a significant amount of air must be drawn to cool the internal combustion engine 12, it might be advantageous to draw the required cooling air from the boundary layer region B developing over the portion of the external surface S of the aircraft.

Typically, an APU is a gas turbine engine that, first, does not require as much cooling as an intermittent internal combustion engine of equal power, and, second, has an efficiency being less than that of gas turbine engines used for propelling the aircraft. Consequently, gas turbine engine APUs are not typically used when the aircraft is flying. Therefore, the compressed air for pressurizing a cabin of the aircraft and power required for operating the different systems of the aircraft comes from the gas turbine engines that propel the aircraft.

Having the internal combustion engine 12 being an intermittent internal combustion engine (e.g., rotary engine), with or without turbo-compounding, might allow using said APU when the aircraft is flying at least because its efficiency might be the same, or better, than that of the gas turbine engines that propel the aircraft. This is especially the case when the main engines are throttled back for descent, approach and landing. Furthermore, in climb, where propelling engines of the aircraft are highly pushed to high power/thrust, using the APU with near efficiency might allow to generate the required electrical power of the aircraft and compressed air for the cabin pressurization solely with the APU instead of with, or in combination with, the propelling engines. This might allow a reduction of the temperature inside the propelling engines compared to a configuration without the disclosed engine assembly 10. This might extend life span of the propelling engines and/or might allow using smaller propelling engines than an aircraft not equipped with the disclosed engine assembly 10. Moreover, the added cost of operating the APU might be compensated by the reduction in drag resulting from the suction of the boundary layer. This might not be possible with a conventional gas turbine engine APU because the amount of air required for its cooling might not be sufficient to create a drag reduction by boundary layer suction. Indeed, in a particular embodiment, an intermittent internal combustion engine, such as the turbo-compounded engine 100 shown in FIG. 1, might have from about 15 to 25 more heat to dissipate than a conventional gas turbine engine APU of equal power. Stated otherwise, the amount of air required for cooling a conventional gas turbine engine APU may not be sufficient to impart a drag reduction that would compensate for the cooling drag. Furthermore, a conventional gas turbine engine APU might not be efficient enough to be used extensively in flight. Conventional gas turbine engine APUs might not be able to provide enough power at high altitude to provide pressurized air to the aircraft while unloading the propelling engines in climb at, or descent from, high altitude. Moreover, a conventional gas turbine engine APU dissipate almost all of its heat in the exhaust gases it expels and, thus, there might not enough heat to dissipate to warrant an effective boundary layer suction.

Still referring to FIG. 1, the engine assembly 10 further includes a porous surface 50 that is configured for defining the portion of the external surface S of the aircraft. A plurality of apertures 50a are defined through the porous surface 50. Different embodiments are described herein below with reference to FIGS. 2-4. The inlet 30a of the air conduit 30 is fluidly connected to the environment E via the apertures 50a of the porous surface 50. In operation, the forced air system 40 induces the airflow F through the apertures 50a of the porous surface 50 following arrow A1 and in the air conduit 30 thereby suctioning the boundary layer. This might result in a reduction of the height of the boundary layer over the portion of the external surface S of the aircraft compared to a configuration in which the boundary layer is not suctioned.

As illustrated, the housing 12a of the internal combustion engine 12 is in heat exchange relationship with the porous surface 50. Different embodiments providing such a heat exchange relationship between the housing 12a of the internal combustion engine 12 and the porous surface 50 are described below with respect to FIGS. 2-4. Heating the porous surface 50 might be advantageous because it might increase a temperature of the air that enters the air conduit 30 via the apertures 50a of the porous surface 50. In a particular embodiment, heating the porous surface 50 allows for de-icing the portion of the external surface S (e.g., wings) of the aircraft and/or to prevent ice from accumulating on said surface. The air entering the air conduit 30 has more energy compared to a configuration in which the porous surface 50 is not heated. In a particular embodiment, increasing the energy of the air entering the air conduit 30 increases its velocity when it is expelled from the air conduit 30 compared to configuration in which the air entering the air conduit 30 is not heated. When the air is expelled in a direction corresponding to that of the movement of the aircraft, the air might generate a thrust that helps the gas turbine engine used for propelling the aircraft and that might reduce the cooling drag.

Still referring to FIG. 1, the engine assembly 10 may further include a heat exchanger 60. The heat exchanger 60a has at least one first conduit 60a which may correspond to the portion 20b of the coolant circuitry 20 and hence configured for circulating the liquid coolant. The heat exchanger 60 has at least one second conduit 60b that is in heat exchange relationship with the at least one first conduit 60a. The at least one second conduit 60b of the heat exchanger 60 is fluidly connected to the air conduit 30. Stated otherwise, the at least one second conduit 60a of the heat exchanger 60 is in fluid flow communication with the environment E via the apertures 50a of the porous surface 50 and via the air conduit 30. In a particular embodiment, the engine assembly 10 includes an oil circuitry; the oil circuitry may be in fluidly flow communication with at least one third conduit of the heat exchanger 60, the at least one third conduit of the heat exchanger 60 being in heat exchange relationship with the at least one second conduit 60b of the heat exchanger 60.

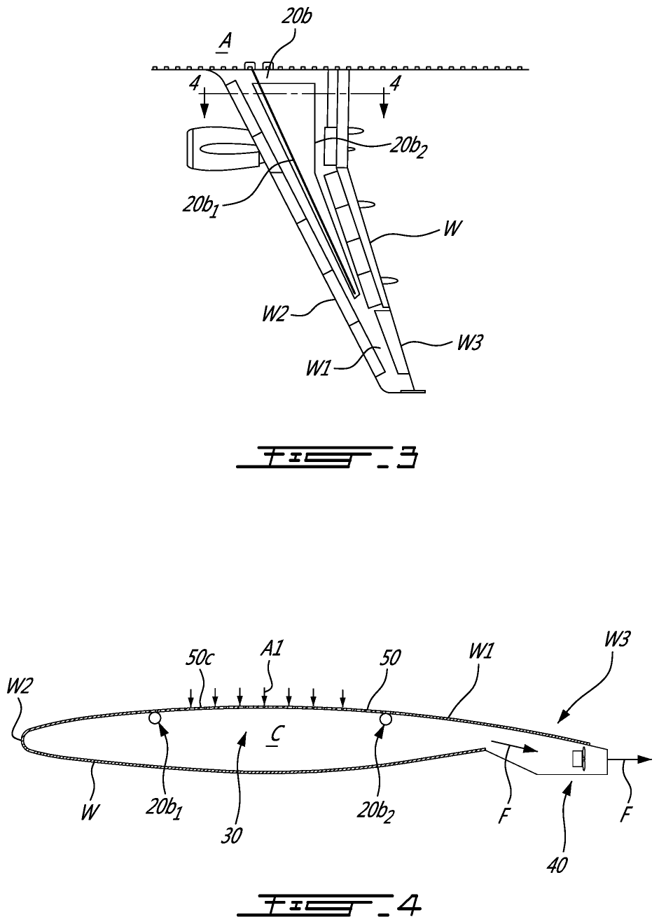

Referring now to FIG. 2, a possible implementation of the engine assembly 10 is illustrated. As shown, the engine assembly 10, which includes the turbo-compounded engine 100, is located inside an APU section V of the aircraft A (FIG. 3). Typically, the APU section V is located in a rear, or tail section of a fuselage of the aircraft A. The porous surface 50 may be a portion of an external surface of the fuselage of the aircraft A that separates an interior of the APU section V and the environment E outside the aircraft A. In the depicted embodiment, the air conduit 30 corresponds to the interior of the APU section V; the internal combustion engine 12 being located inside the air conduit 30. In the depicted embodiment, the external surface of the fuselage of the aircraft defines a scoop 70 that corresponds to the inlet 30a of the air conduit 30. The scoop 70 may be used for suctioning the boundary layer. The scoop may be a NACA style scoop or any other suitable shape. A porous surface on the fuselage of the aircraft with no outside catcher or scoop may be used.

In the embodiment shown, the APU section V defines an outlet 30b and a pipe 80 is fluidly connected to the outlet 30b of the APU section V. The forced air system 40 is fluidly connected to the pipe 80. In the embodiment shown, the forced air system 40 includes a fan 40a that is rotatable about an axis of rotation R within a fan casing 40b. The forced air system 40 is configured for directing the airflow F along a direction parallel to the axis R around which the fan 40a rotates.

The fan casing 40b has a cylindrical wall that defines an inlet for receiving the air that enters the APU section via the scoop 70. The inlet of the fan casing are apertures defined through the cylindrical wall of the fan casing 40b. Therefore, the air enters the fan casing in a substantially radial direction relative to the axis of rotation R of the fan 40a.

In the depicted embodiment, the heat exchanger 60 is secured to the fan casing 40b. The at least one second conduit 60b (FIG. 1) of the heat exchanger 60 is fluidly connected to the inlet of the fan casing 40b. As illustrated, the heat exchanger 60 includes three heat exchanger sections 60′ circumferentially distributed around the axis of rotation R of the fan 40a and the inlet of the fan casing 40b includes three apertures defined through the cylindrical wall; each of the at least one second conduit 60b of three heat exchanger sections 60′ being fluidly connected to the outlet 30b of the APU section V via a respective one of the three apertures defined through the cylindrical wall of the fan casing 40b. The portion of the coolant circuitry 20b is in heat exchange relationship with each of the at least one second conduit 60b of the three heat exchanger sections 60′. The coolant circuitry 20 may circulate serially in each of the three heat exchanger sections 60′, one after the other. Alternatively, the coolant circuitry 20 may be divided in three sub-conduits; each of the three sub-conduits circulating in a respective one of the three heat exchanger sections 60′.

In operation, the airflow enters the APU section V via the scoop 70, flows around the turbo-compounded engine 100, enters the at least one second conduit 60b of each of the three heat exchanger sections 60′ in the substantially radial direction relative to the rotation axis R of the fan 40a, and is expelled out of the APU section V by the fan 40a along an axial direction relative to the rotation axis R.

The liquid coolant enters the coolant flow path 12b of the housing 12a, picks up heat form the housing 12a, is directed in the heat exchanger 60 where it transfers its heat to the airflow F that circulate from the scoop 70 to the forced air system 40, and is directed back toward the housing 12a. By being heated through the heat exchanger 60, a thrust generated by the airflow F when expelled out of the APU section V via the forced air system is greater than that of a configuration in which the airflow F is not heated.

As shown in FIG. 2, by being located inside the air conduit 30, the housing 12a of the internal combustion engine 12 may transfer its heat to the portion of the external surface 50 of the aircraft by convection and/or conduction through a layer of air L between the housing 12a and said surface 50. Heat might be transferred from the housing 12a to the surface 50 by radiation.

Referring now to FIGS. 3 and 4, alternatively or in addition, the porous surface 50 is an external surface of a wing W of the aircraft. In the depicted embodiment, the porous surface 50 is located on a suction side W1 of the wing W. The portion of the coolant circuitry 20b extends along a span of the wing W and is in heat exchange relationship with the porous surface 50. The portion of the coolant circuitry 20b may be in contact with the porous surface 50 to transfer the heat of the liquid coolant to the porous surface 50.

In the depicted embodiment, the portion of the coolant circuitry 20b that is in contact with the porous surface 50 of the wing W of the aircraft A has a first section 20b1 and a second section 20b2. The first section 20b1 extends from a root of the wing W toward a remote end located adjacent a tip of the wing W and the second section 20b2 extends from the remote end of the first section 20b1 back to the root of the wing W. The first and second sections 20b1, 20b2 of the portion of the coolant circuitry 20 are offset along a chord-wise direction of the wing W; the first section 20b2 being closer to a leading edge W2 of the wing W than the second section 20b2. In the depicted embodiment, an average temperature of the liquid coolant in the first section 20b2 is greater than that in the second section 20b2. Stated otherwise, the liquid coolant, after exiting the coolant flow path 12b of the housing 12a of the internal combustion engine 12 circulates in the first section 20b1 adjacent the leading edge W1 of the wing W before it circulates in the second section 20b2 adjacent the trailing edge W3 of the wing W.

In the embodiment shown, the air conduit 30 is defined by a cavity C inside the wing W, between its pressure and suction sides and its leading and trailing edges. The force air system 40 includes a fan fluidly connected to the cavity C inside the wing W and to the environment E outside the aircraft A via the porous surface 50 and located adjacent the trailing edge W3 of the wing W. The forced air system 40 may include a plurality of fans distributed at a plurality of spanwise locations along a span of the wing W.

Referring to all figures, for operating the engine assembly 10 the portion of the external surface of the aircraft A being porous is heated with heat generated by the internal combustion engine 12. The airflow F is drawn from the boundary layer region B located over the portion of the external surface to the air conduit 30. The airflow F is heated while circulating in the air conduit 30 by cooling a liquid coolant being in heat exchange relationship with the housing 12a of the internal combustion engine 12. In the embodiment shown, drawing the airflow F includes operating a fan 40a fluidly connected to the air conduit 30.

Referring more particularly to FIG. 2, the internal combustion engine 12 is in the air conduit 30, heating the portion of the external surface S includes heating the layer of air L located between the housing 12a and the porous surface 50 by the housing 12a.

Referring more particularly to FIGS. 3-4, heating the portion of the external surface S includes transferring heat from the liquid coolant to the portion of the external surface via the contact between the conduit 20a circulating the liquid coolant and the portion of the external surface S.

Referring more particularly to FIGS. 1-2, heating the airflow F includes circulating the liquid coolant in the at least one first conduit 60a of the heat exchanger 60 and circulating the airflow F in the at least one second conduit 60b of the heat exchanger 60.

In a particular embodiment, the disclosed engine assembly 10 allows using an APU of the intermittent internal combustion engine type while the aircraft is flying. This might allow all the power generated by the gas turbine engines of the aircraft for propulsion instead of using a portion of the generated power for pressurizing the cabin and operating the different systems of the aircraft. This might cause a reduction in fuel consumption of the aircraft because the disclosed turbo-compounded engine might be more efficient than the gas turbine engines used for propelling the aircraft.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. An engine assembly, comprising:
a liquid-cooled internal combustion engine having a housing, the internal combustion engine including a coolant circuitry for circulating a liquid coolant, the coolant circuitry in heat exchange relationship with the housing;
a porous surface configured for defining a portion of an external surface of an aircraft, apertures defined through the porous surface, the housing of the internal combustion engine in heat exchange relationship with the porous surface for heating the porous surface;
an air conduit having an inlet fluidly connected to a boundary layer region outside the engine assembly and adjacent the porous surface via the apertures of the porous surface, the air conduit in heat exchange relationship with the coolant circuitry; and
a forced air system fluidly connected to the inlet of the air conduit and operable to draw an airflow from the inlet and inside the air conduit.

2. The engine assembly of claim 1, wherein the internal combustion engine is located inside the air conduit.

3. The engine assembly of claim 1, wherein the housing of the internal combustion engine is in heat exchange relationship with the porous surface via a portion of the coolant circuitry.

4. The engine assembly of claim 3, wherein the portion of the coolant circuitry is in contact with the porous surface.

5. The engine assembly of claim 1, wherein the forced air system is a fan adjacent an outlet of the air conduit.

6. The engine assembly of claim 1, wherein the internal combustion engine is a rotary engine.

7. The engine assembly of claim 1, further comprising a heat exchanger having at least one first heat exchanger conduit and at least one second heat exchanger conduit in heat exchange relationship with the at least one first heat exchanger conduit, the at least one first heat exchanger conduit being part of the coolant circuitry and configured for circulating the liquid coolant, the at least one second heat exchanger conduit fluidly connected to the air conduit.

8. An engine assembly, comprising:
a turbo-compounded engine including a rotary internal combustion engine having an housing and an engine shaft, the intermittent internal combustion engine including a coolant circuitry for circulating a liquid coolant, the coolant circuitry in heat exchange relationship with the housing, and a turbine having a turbine shaft, the turbine having an inlet fluidly connected to an exhaust of the intermittent internal combustion engine, the turbine shaft in driving engagement with the engine shaft;
a porous surface configured for defining a portion of an external surface of an aircraft, apertures defined through the porous surface, the housing of the internal combustion engine in heat exchange relationship with the porous surface for heating the porous surface;
an air conduit having an inlet fluidly connected to a boundary layer region outside the engine assembly via the apertures of the porous surface, the air conduit in heat exchange relationship with the coolant circuitry;
a forced air system fluidly connected to the inlet of the air conduit and operable to draw an airflow from the inlet and inside the air conduit.

9. The engine assembly of claim 8, wherein the turbo-compounded engine is located inside the air conduit.

10. The engine assembly of claim 8, wherein the housing of the intermittent internal combustion engine in heat exchange relationship with the porous surface via a portion of the coolant circuitry.

11. The engine assembly of claim 10, wherein the portion of the coolant circuitry is in contact with the porous surface.

12. The engine assembly of claim 8, wherein the forced air system is a blower adjacent an outlet of the air conduit.

13. The engine assembly of claim 8, wherein the rotary internal combustion engine is a Wankel engine.

14. The engine assembly of claim 8, further comprising a heat exchanger having at least one first heat exchanger conduit and at least one second heat exchanger conduit in heat exchange relationship with the at least one first heat exchanger conduit, the at least one first heat exchanger conduit fluidly connected to the coolant circuitry for circulating the liquid coolant, the at least one second heat exchanger conduit fluidly connected to the air conduit.

15. The engine assembly of claim 8, further comprising a compressor having an inlet fluidly connected to an environment outside of the engine assembly and an outlet fluidly connected to an inlet of the intermittent internal combustion engine, the compressor in driving engagement with the turbine shaft.

16. A method of operating an engine assembly comprising:
heating a portion of an external surface of an aircraft being porous with heat generated by an internal combustion engine;
drawing an airflow from a boundary layer region located over the portion of the external surface to an air conduit; and
heating the airflow while circulating the airflow in the air conduit by cooling a liquid coolant being in heat exchange relationship with a housing of the internal combustion engine.

17. The method of claim 16, wherein the internal combustion engine is in the air conduit, heating the portion of the external surface includes heating a layer of air located between the housing and the porous surface by the housing.

18. The method of claim 16, wherein heating the portion of the external surface includes transferring heat from the liquid coolant to the portion of the external surface via a contact between a conduit circulating the liquid coolant and the portion of the external surface.

19. The method of claim 16, wherein drawing the airflow includes operating a fan fluidly connected to the air conduit.

20. The method of claim 16, wherein heating the airflow includes circulating the liquid coolant in at least one first conduit of a heat exchanger and circulating the airflow in at least one second conduit of the heat exchanger, the at least one second conduit in heat exchange relationship with the at least one first conduit.
